(19) United States
(12) Patent Application Publication
(10) Pub. No.: US 2015/0032511 A1
(43) Pub. Date: Jan. 29, 2015

(54) METHOD AND SYSTEM FOR DEMOGRAPHIC, ENVIRONMENTAL, BUSINESS AND/OR OPERATIONAL INFORMATION COLLECTION AND PROCESSING

(71) Applicant: PECABU, INC., San Mateo, CA (US)

(72) Inventors: Rabih Haddad, Burlingame, CA (US); William Colwell, San Mateo, CA (US)

(73) Assignee: PECABU, INC., San Mateo, CA (US)

(21) Appl. No.: 14/337,717

(22) Filed: Jul. 22, 2014

Related U.S. Application Data
(60) Provisional application No. 61/857,874, filed on Jul. 24, 2013.

(51) Int. Cl. G06Q 30/02

(52) U.S. Cl. CPC G06Q 30/0205
USPC 705/7.34

(57) ABSTRACT

In some embodiments, a non-transitory processor-readable medium stores code representing instructions to be executed by a processor that can cause the processor to receive from mobile compute devices demographic information associated with users of such mobile compute devices and the indication of the locations of such mobile compute devices and the time. The code causes the processor to identify based on the indication of the location and the time, a collection of mobile compute devices that are within a geographic area during a time period. The code causes the processor to receive from a remote sensory device, environmental information associated with the geographical area during the time period. The code causes the processor to correlate the demographic information with the environmental information to define a trend associated with the geographic area and the time period and send a signal including an indicator associated with the trend.

### CROSS-REFERENCE TO RELATED APPLICATIONS

This application claims priority to and the benefit of U.S. Provisional Application Ser. No. 61/857,874, entitled “Method and System for Demographic, Environmental, Business and/or Operational Informational Collection and Processing,” filed Jul. 24, 2013, which is incorporated herein by reference in its entirety.

This application is related to co-pending U.S. Non-Provisional patent application having Attorney Docket No. PECA-002/01US 320013-2006, filed on the same date, and entitled “Method and System for Advertising Prediction, Improvement and Distribution”, which is incorporated herein by reference in its entirety.

### BACKGROUND

Some embodiments described herein relate generally to methods and apparatus for real world data collection, processing and output. In particular, but not by way of limitation, some of the embodiments described herein relate to methods and apparatus for measuring, processing and generating demographic, environmental, business and operational data as they relate to multiple physical locations over time. More particularly, some of the embodiments described herein relate to methods and apparatus for providing insights into past, current and future trends for optimization and utility in other services.

Collection of accurate data in regards to the movement and flow of demographic information within an environment is highly pertinent to several fields including, but not limited to: advertising/marketing, urban planning, incentive/loyalty programs, social sciences and research in multiple fields. Additionally, the relationship between demographic data and environmental data such as, for example, weather, breaking news stories, noise levels, transit system information, is also significant. As used herein, “demographic, environmental, business and operational” data is referred to as DEBO data.

The Internet has been built on a backbone of measurement and automation. For example, billions of key presses, mouse clicks, selection of “like” options, selection of “dislike” options and more are recorded every day. These inputs feed into a multitude of service-based websites such as, for example, Facebook, Google, Yahoo, and can customize and optimize the Internet experience for billions of users. The user's actions, history and preferences are among the multitude of factors that are used for optimizing the online experience. This level of optimization is currently available for online applications.

Some online-based businesses such as, for example, Amazon and Ebay take advantage of the large database of preferences and history for multitudes of users. Such business enterprises can adapt and modify their websites per user according the length of time a user spends on their website, the number of key presses, the purchase history of a user, the browsing history of a user, the amount of purchases made by a user, the number of links clicked, and/or the like. This feedback information can be integrated seamlessly into the e-commerce model of business. For example, an online advertising campaign can be setup that can target a specific demographic, at a specific time, in specific countries that can reliably provide a successful campaign and relevant feedback. Unlike the online world, however, measurement and automation in the real world has made no such great technological and methodological leap.

For example, to measure street traffic, real-estate projects, some municipalities and countries either use simple trip wire counters, employees with handheld counters or make educated guesses (that are prone to error) to obtain estimates. Hence, to know the DEBO information at a certain area at a specific time, municipalities and countries currently make very rough estimates/guesses.

Although some known systems use cameras with facial recognition software to determine demographics at specific locations, such systems are error prone, invade privacy and are susceptible to manipulation and thus are not in widespread use. Additionally, such systems can be expensive (costing in the tens of thousands of dollars) and involve complex and time-consuming setup by technicians. By not being an opt-in system that can allow users to chose whether they want to be part of the calculation, such systems can invade personal privacy by scanning a face for personal characteristics without explicit permission that can lead to potential current and future legal problems. Furthermore, the DEBO databases that currently exist, often are of poor resolution, scope (city or nation-wide), very limited in the metrics they track, difficult to use, expensive to access and difficult to connect with other databases for performing extensive analysis.

Accordingly, a need exists for methods and apparatus for measuring demographic, environmental, business and operational data associated with multiple geographic regions over time that can provide insights into past and current trends, and can help predict future trends in multiple geographic areas for optimization and utility in a variety of services.

### SUMMARY

In some embodiments, a non-transitory processor-readable medium stores code representing instructions to be executed by a processor that cause the processor to receive from each mobile compute device from a set of mobile compute devices demographic information associated with a user of that mobile compute device. The code also causes the processor to receive from each mobile compute device from the set of mobile compute devices, an indication of a location of that mobile compute device and an indication of a time associated with that location. The code further causes the processor to identify based on the indication of the location and the indication of the time associated with each mobile compute device from the set of mobile compute devices, a collection of mobile compute devices from the set of mobile compute devices that are identified as being within a geographic area during a time period. In such embodiments, the code causes the processor to receive from a remote sensory device associated with the geographic area, environmental information associated with the geographical area during the time period. The code also causes the processor to correlate based on the geographic area and the time period, the demographic information associated with the set of mobile compute devices with the environmental information to define a trend associated with the geographic area and the time period. The code further causes the processor to send a signal including an indicator associated with the trend.

### BRIEF DESCRIPTION OF THE DRAWINGS

FIG. 1 is a schematic illustration of the different components of a DEBO (measurement and prediction) system and external applications, according to an embodiment.

FIG. 2 is a schematic illustration of a system for measuring demographic, environmental, business and operational data associated with multiple physical locations over time, according to an embodiment.

FIG. 3 illustrates an example of the file structure of a DEBO database in the central server, according to an embodiment.

FIG. 4 is a flowchart illustrating a method used by a mobile compute device to repeatedly or regularly track its location and transmit the location information to the central server to be processed into demographic information, according to an embodiment.

FIG. 5 is a flowchart illustrating a method used by a remote sensory device to receive environmental data and periodically transmit the environmental data to the central server, according to an embodiment.

FIG. 6 is a block diagram of a DEBO system used to deliver relevant advertising content to an advertising media, according to an embodiment.

FIG. 7 is a flowchart illustrating a method of correlating DEBO parameters to define a trend associated with a geographic area and a time period, according to an embodiment.

### DETAILED DESCRIPTION

In some embodiments, a non-transitory processor-readable medium stores code representing instructions to be executed by a processor that causes the processor to receive from each mobile compute device from a set of mobile compute devices demographic information associated with a user of that mobile compute device. The code also causes the processor to receive from each mobile compute device from the set of mobile compute devices, an indication of a location of that mobile compute device and an indication of a time associated with that location. The code further causes the processor to identify based on the indication of the location and the indication of the time associated with each mobile compute device from the set of mobile compute devices, a collection of mobile compute devices from the set of mobile compute devices that are identified as being within a geographic area during a time period. In such embodiments, the code causes the processor to receive from a remote sensory device associated with the geographic area, environmental information associated with the geographical area during the time period. The code also causes the processor to correlate based on the geographic area and the time period, the demographic information associated with the set of mobile compute devices with the environmental information to define a trend associated with the geographic area and the time period. The code further causes the processor to send a signal including an indicator associated with the trend.

In some embodiments, an apparatus includes a mobile data collection module implemented in at least one of a memory or a processing device that can repeatedly receive from each mobile compute device from a set of mobile compute devices, an indication of a location of that mobile compute device and an indication of a time associated with the location. The apparatus also includes an environmental data collection module that can repeatedly receive from a remote sensory device associated with a geographic area, environmental information associated with the geographic area during the time period. The apparatus further includes a correlation module operatively coupled to the mobile device data collection module and the environmental data collection module. In such embodiments, the correlation module can identify a collection of mobile compute devices from the set of mobile compute devices based on a correlation between (1) a geographic area and a time period associated with the remote sensory device and (2) the location and the time for each mobile compute device from the set of mobile compute devices. In such embodiments, the apparatus also includes a prediction module that can predict a trend associated with the geographic area and the time period associated with the remote sensory device based on the set of mobile compute devices, where the prediction module can send a signal including an indication of the trend.

In some embodiments, a non-transitory processor-readable medium stores code representing instructions to be executed by a processor that causes the processor to receive from each mobile compute device from a set of mobile compute devices demographic information associated with a user of that mobile compute device and an indication of a location of that mobile compute device. The code also causes the processor to identify based on the indication of the location associated with each mobile compute device from the set of mobile compute devices, a collection of mobile compute devices (1) from the set of mobile compute devices and (2) identified as being within a geographic area. The code also causes the processor to receive business information associated with the geographic area. The code further causes the processor to receive from a remote sensory device associated with the geographic area, environmental information associated with the geographic area, and correlate based on the geographic area, (1) the demographic information associated with the collection of mobile compute devices with the (2) business information and the environmental information, to define a trend associated with the geographic area and send a signal including an indicator associated with the trend.

In some embodiments, a method includes the collection and processing of demographic, environmental, business and operational (sometimes referred to herein as a “DEBO”) data for various potential uses.

As used herein, demographic data includes any piece of information that can be connected to at least one personal attribute of an individual. Such demographic data as pertaining to an individual or a group of individuals may include, for example, age, sex, physical attributes, marital status, income, physical characteristics, home address, employer and/or the like.

As used herein, environmental data includes any piece of information that can be connected to a specific location at any point in time, or over a given time span. Such environmental data may include, for example, temperature, wind direction, wind speed, number of people nearby (referred to as people count), number of vehicles nearby (referred to as car count), rain fall, pollution levels, allergen levels, ambient light, and/or the like.

As used herein, business data includes any piece of information that can be connected to a business, corporation, individually-owned company or partnership. Such business data may include, for example, product stocks, sales figures, operating hours, financial data, sales targets, profit margins, employee data, customer data, and/or the like.

As used herein, operational data includes any piece of information that can be connected to a device or a service. Such operational data may include, for example, device status, operating temperature of a device, rate of predicting, efficiency data, current load on a device, errors, warnings, versions, number of connected users, and/or the like.

As used herein, predicted data includes any piece of DEBO data that is estimated or predicted based at least partially on historical DEBO trends. The predicted data can be generated by using predictive calculations or algorithms such as, for example, lasso and elastic-net regularized generalized linear models and/or ensembles of decision trees (random forests).

As used herein, a module can be, for example, any assembly and/or set of operatively-coupled electrical components associated with performing a specific function(s), and can include, for example, a memory, a processor, electrical traces, optical connectors, software (that is stored in memory and/or executing in hardware) and/or the like.

As used herein, a user can be, for example, any person that is using a mobile compute device on which an application is installed that can transmit user demographic, location and time data to a central server. Moreover, used in this specification, a user may or may not be the owner of the mobile compute device.

The term “social media” refers to online social networks that build online communities of people, who share interests and/or activities, or who are interested in exploring the interests and activities of others. Most social media are web-based and provide a variety of ways for users to interact such as, for example, via electronic maim (email), file sharing, instant messaging services, and/or the like. Examples of some social media include, but are not limited to, Facebook, Twitter, Yelp, and so forth.

As used in this specification, the singular forms “a,” “an” and “the” include plural referents unless the context clearly dictates otherwise. Thus, for example, the term “a central server” is intended to mean a single central server or a combination of central servers.

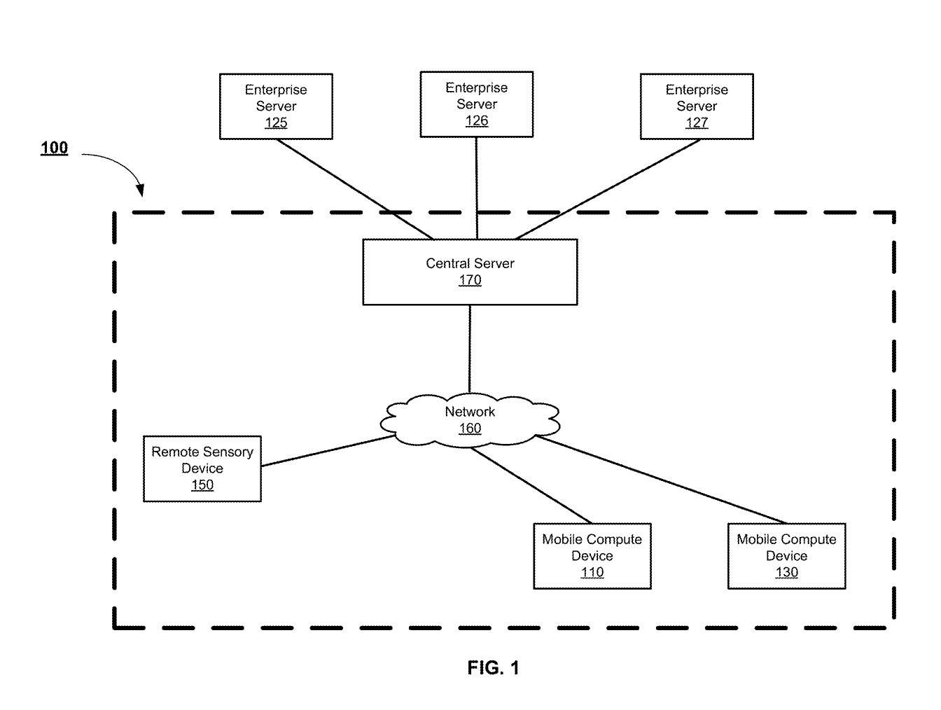

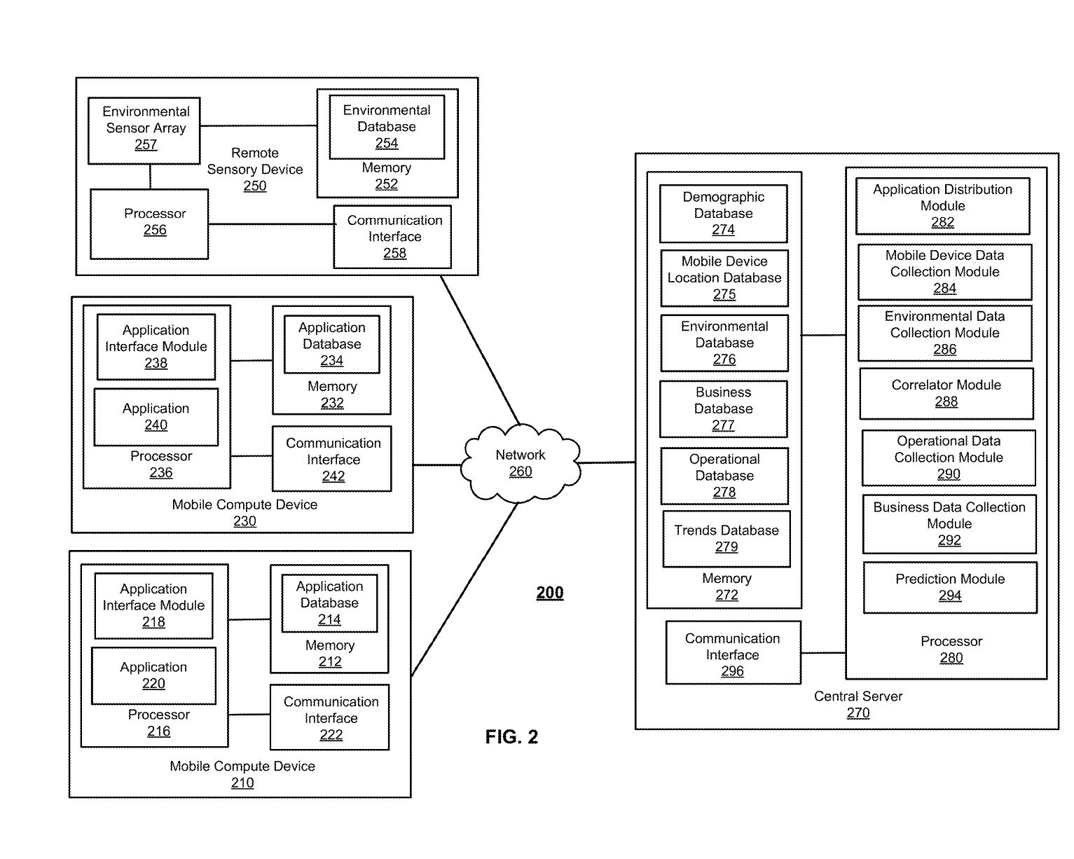

FIG. 1 is a schematic illustration of the different components of a DEBO (measurement and prediction) system and external applications, according to an embodiment. The different components of the DEBO system are contained within the dashed box 100. FIG. 1 illustrates a central server 170 operatively coupled with other devices. For example, the central server 170 is operatively coupled to two mobile compute devices 110 and 130 and at least one remote sensory device 150. FIG. 1 shows the central server 170 operatively coupled to two mobile compute devices 110 and 130 and one remote sensory device 150 as an example only, and not a limitation. In other configurations, the central server 170 can be operatively coupled to more than two (i.e., multiple) mobile compute devices and more than one (i.e., multiple) remote sensory devices. In some configurations, the connections between the central server 170 and the other devices can be direct, via a network 160 (e.g., the Internet), using a wireless protocol, a wired protocol, and/or a mixture of wired and wireless protocols. Furthermore, the architecture and/or hardware depicted and described with respect to FIG. 1 can be used in the embodiments and methods shown and described herein with respect to FIGS. 2-7. For example, the central server 170 shown and described with respect to FIG. 1 can be the similar to the central server shown and described in relation to FIG. 2.

In FIG. 1 and as used herein, mobile compute devices 110 and 130 can include any device that can be used by an individual or a user to perform computation and/or to communicate with other devices. Such mobile compute devices can be portable and can include a communication element and a processing element. The mobile compute devices 110 and 130 can be, for example, smart phones, cellular phones, laptop computers, tablets, desktop computers, web-enabled appliances vehicles with internet capabilities, and/or the like. Mobile compute devices will be described in greater detail below in relation to FIG. 2.

In FIG. 1 and as used herein, remote sensory devices 150 (sometimes referred to herein as an “RSD”) can include any device that can sense the surrounding environment and can communicate that information over the network 160 (e.g., the Internet). Such devices are typically stationary and can include communication elements, sensory elements, and/or a processing element. Such devices can record a range of environmental data through a series of sensors (also referred to as a sensor array). Additionally, such remote sensory devices 150 can communicate with the central server 170 through any number of wireless protocols. The wireless protocols may include, for example, cellular networks, Wi-Fi®, WIMAX, in any current or future versions, and/or the like. Remote sensory devices 150 will be described in greater detail herein in relation to FIG. 2.

The network 160 can be any type of network (e.g., a local area network (LAN), a wide area network (WAN), a virtual network, and/or a telecommunications network) implemented as a wired network and/or a wireless network and can include an intranet, an Internet Service Provider (ISP) and the Internet, a cellular network, and/or the like. In FIG. 1 and as used herein, the central server 170 includes any server or cloud-based device that can be used by an enterprise (e.g., a company, an organization, etc.) to store, compute or communicate data. The central server 170 can be typically stationary and can have storage elements, communication elements and processing elements. The central server 170 can include multiple components such as, for example, rack mounted servers, tower servers, blade servers, mainframes, computing clusters, cloud computing services, cloud storage services, storage arrays, redundant array of independent disks (RAID) storage arrays, and/or the like. The central server 170 can be connected to the Internet via high speed connections such as T-level connections, fiber optics connections, and/or the like. The central server 150 will be described in greater detail herein in relation to FIG. 2.

In the embodiment of the DEBO system illustrated in FIG. 1, the RSD 150 can collect environmental data at various locations throughout a given environment (e.g., city, state, country, globally, etc.). Environmental data can be collected by the RSDs 150 using sensor or sensor arrays that can be either directly mounted to the RSDs 150 and/or operably coupled to the RSDs 150. Such sensor arrays can include, for example, cameras, microphones, weather sensors, and/or the like. Such sensors can measure current weather data and sound data, as well as use cameras to count and measure the number of people and vehicles in a pre-determined vicinity of the RSD 150. The resulting environmental data can be accumulated and compressed into a data packet or a stream of data packet by the RSD 150 and transmitted to the central server 170 for storage and further processing. RSDs 150 will be described in greater detail herein in relation to FIG. 2.

Demographic data can be collected by a set of mobile compute devices 110 and 130 (i.e., personal devices) and transmitted periodically back to the central server 170 via the network 160 (e.g., an Internet connection) to establish a demographic presence at a specific location at different time periods. In some instances, some environmental data such as, for example, the local temperature, the ambient light levels, and so forth can also be collected by mobile compute devices 110 and 130 and transmitted to the central server 170.

Business data can be collected directly by the central server 170. Periodic queries, with parameters defined by the business owner, can be sent from the central server 170 to a business database via the network 160 (e.g., over the Internet). The query results can be sorted by geographical location and business metric and can be sent to the central server 170 for storage and further processing. Operational data can also be collected directly by the central server 170. In some instances, periodic requests for sensor readings can be sent by the central server 170 to a wide range of sensors designed to give operational feedback over the network 160 (e.g., the Internet). The resulting operational data obtained by the central server 170 can be sorted by geographical location and type (Boolean, counter, float, text, etc.) and stored in the central server 170. The method for collection of business data and operational data by the central server 170 will be described in greater detail herein in relation to FIG. 2.

The central server 170 can collect and organize the demographic, environmental, business and operational (DEBO) data into multiple databases (not shown in FIG. 1). The central server 170 can implement various correlation methods to correlate the different kinds of DEBO data associated with a specific geographic area and a given time period to generate and/or define a trend associated with that geographic area at a given time period. Such trends can also be stored in databases on or accessible by the central server 170, where such (historical) trends can be used to predict a future trend in that geographical area by the central server 170. The different kinds of DEBO data stored in the different databases can be queried by a variety of external entities such as the third party enterprise servers 125-127 to use the information for predictive use. Such external entities or applications can be for, for example, advertising networks, research institutions, business research, marketing planners and strategists, urban planners, news networks, and/or the like.

In some instances, the DEBO system shown in FIG. 1 can be used to predict current (and not yet detected) or future DEBO readings using historical (or stored) DEBO data. As will be discussed in greater detail in relation to FIG. 2, the DEBO data is stored in multiple databases on or accessible by the central server 170 and collected over time as it relates to a number of geographic areas. A customer (e.g., a user or owner of the enterprise server 125) then may request a prediction of the DEBO data at a specific geographic area currently or at a future point in time. The DEBO system 100 then can use the previous historical (or stored) DEBO data contained within the database to project forward the DEBO conditions in the future. The method, calculation and/or algorithm used could be one or more of the known predictive analysis and modeling methods.

FIG. 2 is a schematic illustration of a system for measuring demographic, environmental, business and operational data associated with multiple physical locations over time, according to an embodiment. The DEBO measurement system 200 includes a first mobile compute device 210, a second mobile compute device 230, a remote sensory device 250, a network 260 and a central server 270. Note that the DEBO measurement system 200 in FIG. 2 shows two mobile compute devices 210 and 230 as an example only, and not a limitation. In other configurations, the DEBO measurement system 200 can include multiple mobile compute devices that can be associated with users in any given geographical location at any given time. The network 260 can be any type of network (e.g., a local area network (LAN), a wide area network (WAN), a virtual network, and/or a telecommunications network) implemented as a wired network and/or a wireless network and can include an intranet, an Internet Service Provider (ISP) and the Internet, a cellular network, and/or the like. As described in further detail herein, in some configurations, for example, the mobile compute device 210 and/or the mobile compute device 230 and/or the remote sensory device 250 can be connected to the central server 270 via network 260.

The mobile compute devices 210 and 230 can each be any mobile communication or computing device such as a laptop computer, a personal digital assistant (PDA), a standard mobile telephone, a tablet personal computer (PC), a smart phone, and/or so forth that can be used by a user (i.e., an individual) to perform computations and/or to communicate with other devices. Hence, only the structure and function of the different components of the mobile compute device 210 will be discussed in detail herein. It is to be understood that the structure and functionality of mobile compute device 230 is substantially similar to that of mobile compute device 210.

The mobile compute device 210 includes a memory 212, a processor 216 and a communication interface 222. The memory 212 can be, for example, a random access memory (RAM), a memory buffer, a hard drive, a database, an erasable programmable read-only memory (EPROM), an electrically erasable read-only memory (EEPROM), a read-only memory (ROM) and/or so forth. The memory 212 can store instructions to cause the processor 216 to execute modules, processes and/or functions associated with the mobile compute device 210 and/or the DEBO system 200.

The memory 212 includes an application database 214. The application database 214 can be a lookup table or a dedicated memory space that can store data and/or instructions associated with executing an application 220 (or multiple applications) in the processor 216 of the mobile compute device 210. In one example, such data can include instructions that can be used to install the application 220 on the mobile compute device 210. In another example, such data and/or instructions can include instructions for recording demographic information associated with the user of the mobile compute device 210 (e.g., facial recognition instructions, retinal scan instructions, fingerprint scan instructions, instructions to store user-key added information, etc.).

The processor 216 can be a general purpose processor, a Field Programmable Gate Array (FPGA), an Application Specific Integrated Circuit (ASIC), a Digital Signal Processor (DSP), and/or the like. The processor 216 can run and/or execute applications, modules, processes and/or functions associated with the mobile compute device 210 and/or the DEBO system 200. The processor 216 includes an application interface module 218 and an application 220. The application 220 can be received, for example, via the network 260 from the central server 270.

The application 220 can be and/or include a hardware module(s) and/or a software module(s) (stored in memory 212 and/or executed in a processor 216) that is installed and is executable directly on the mobile compute device 210. The application 220 can cause the processor 216 to execute sub-modules, processes and/or functions associated with the mobile compute device 210 and/or the DEBO system 200. Such functionalities can include for example, obtaining a picture photograph of the user, using infra-red facial recognition systems for obtaining a facial profile of the user, obtaining a retinal scan image of the user, obtaining a fingerprint scan image of the user, obtaining user name, obtaining user date of birth, obtaining user marital status, obtaining user sex, and/or the like. The application 220 can also send such collected demographic data and their associated location and time data to the central server 270 via the network 260.

The application interface module 218 can be and/or include a hardware module(s) and/or a software module(s) (stored in memory 212 and/or executed in a processor 216) that controls input from and/or output to a display unit (not shown in FIG. 2). The display unit can be, for example, a liquid crystal display (LCD) unit or a light emitting diode (LED) alpha-numeric display unit that can display a graphical user interface (GUI) generated by the application 220. The GUI displayed on the display unit via the application interface module 218 can allow the user to interact with the application 220. The GUI may include a set of displays having message areas, interactive fields, pop-up windows, pull-down lists, notification areas, and graphical buttons that can be operated by the user. The GUI may include multiple levels of abstraction including groupings and boundaries. It should be noted that the term “GUI” may be used in the singular or in the plural to describe one or more GUI's, and each of the displays of a particular GUI may enable the user of the mobile compute device 210 to provide the application 220 with demographic data.

The mobile compute device 210 also includes a communication interface 222, which is operably coupled to the communication interface 296 of the central server 270. The communication interface 222 can include one or multiple wireless port(s) and/or wired ports. The wireless port(s) in the communication interface 222 can send and/or receive data units (e.g., data packets) via a variety of wireless communication protocols such as, for example, a wireless fidelity (Wi-Fi®) protocol, a Worldwide Interoperability for Microwave Access (WiMAX) protocol, a cellular protocol (e.g., a third generation mobile telecommunications (3G) or a fourth generation mobile telecommunications (4G) protocol), 4G long term evolution (4G LTE) protocol), and/or the like. In some instances, the wired port(s) in the communication interface 222 can also send and/or receive data units via implementing a wired connection to the central server 270. In such instances, the wired connections can be, for example, twisted-pair electrical signaling via electrical cables, fiber-optic signaling via fiber-optic cables, and/or the like.

The user of the mobile compute device 210 (or 230) can share demographic data with the central server 270. The user can first install the application 220 that can initially send (or share) device information (device type, manufacturer, media access control (MAC) address, the operating system, etc.) with the central server 270 via the network 260. Additionally, if the user agrees to share demographic information, the user can share their demographic data in one of two ways. For example, the user can either manually add the demographic data, or have the application 220 comb through the user's social network information to predict and/or infer a number of demographic data points associated with the user such as, for example, age, income bracket, sex, marital status, and/or the like. The data (the device data and optional demographic data) shared with the central server 270 (regardless of whether the user volunteered to share demographic information with the DEBO system) is sent to the central server 270 for registration of the mobile compute device 210 and user on the platform. Wherever a registered mobile compute device 210 is detected, the associated profile, with possible demographic data, can be cross-referenced, calculated and stored.

The remote sensory device 250 can include any device capable of any form of communication using a wireless network protocol, sensing information about its environment, processing data from an array of sensing equipment that are either directly connected to and/or remotely coupled to the remote sensory device 250, communicating with the central server 270 using a wired or wireless protocol, outputting data in a number of formats based on instructions from the central server 270 and/or the like. The remote sensory device 250 includes a memory 252, a processor 256, an environmental sensor array 257 and a communication interface 258. The memory 252 can be, for example, a random access memory (RAM), a memory buffer, a hard drive, a database, an erasable programmable read-only memory (EPROM), an electrically erasable read-only memory (EEPROM), a read-only memory (ROM) and/or so forth. The memory 252 can store instructions to cause the processor 256 to execute modules, processes and/or functions associated with the remote sensory device 250 and/or the DEBO system 200.

The memory 252 includes an environmental database 254. The environmental database 254 can be a lookup table or a dedicated memory space that can store data and/or instructions associated with executing the different functionalities of the remote sensory device 250. In one example, such data can include instructions for recording environmental information associated with the geographical location of the remote sensory device 250 (e.g., measuring temperature, barometric pressure, rain fall, pollution, air quality, allergens, radioactivity, wind speed, wind direction, water levels, etc.). In another example, the environmental database 254 can store the current and historical values of the measured environmental parameters.

The remote sensory device 250 includes a processor 256 that can be a general purpose processor, a Field Programmable Gate Array (FPGA), an Application Specific Integrated Circuit (ASIC), a Digital Signal Processor (DSP), and/or the like. The processor 256 can run and/or execute applications, modules, processes and/or functions associated with the remote sensory device 250 and/or the DEBO system 200. The remote sensory device 250 can include and/or be operably coupled to an environmental sensor array 257 that can include, for example, one or more individual sensors. Such individual sensors can be, for example, one or more digital cameras, infrared cameras, ultra-violet (UV) light detectors, ambient light level sensors, laser sensors, microphones, weather sensors including instruments for measuring temperature, barometric pressure, rain fall, pollution, air quality, allergens, radioactivity, wind speed, wind direction, water levels, and/or the like. In the embodiment of the DEBO system 200 illustrated in FIG. 2, the remote sensory device 250 can collect environmental data at various locations throughout a given geographical location (e.g., city, state, country, globally, etc.). Environmental data can be collected by the remote sensory device 250 using the environmental sensor array 257 that can be either directly mounted on the remote sensory device 250 and/or remotely coupled to the remote sensory device 250. The environmental sensor array 257 can, for example, measure current weather data and sound data, as well as use cameras to count and measure the number of people and/or vehicles in a given vicinity of the remote sensory device 250. In some configurations, the processor 256 can collect, record, digitize, and compress the environmental data into, for example, a set of data packets and send the data packets or a stream of data packets to the central server 270 via the network 260 (for long-term storage and further processing). In other configurations, the processor 256 can output the collected environmental data in a number of different formats such as, for example, a video as a live stream or pre-recorded, an audio as a live stream or pre-recorded, an advertisement as a video or audio stream or as an image, a text file, an executable computer file, a digital file containing data to be read by another related or unrelated system and/or the like.

The remote sensory device 250 also includes a communication interface 258, which is operably coupled to the communication interface of the central server 270. The communication interface 258 can include one or multiple wireless port(s) and/or wired ports. The wireless port(s) in the communication interface 258 can send and/or receive data units (e.g., data packets) via a variety of wireless communication protocols such as, for example, a wireless fidelity (Wi-Fi®) protocol, a Worldwide Interoperability for Microwave Access (WiMAX) protocol, a cellular protocol (e.g., a third generation mobile telecommunications (3G) or a fourth generation mobile telecommunications (4G) protocol), 4G long term evolution (4G LTE) protocol), and/or the like. In some instances, the wired port(s) in the communication interface 258 can also send and/or receive data units via implementing a wired connection to the central server 270. In such instances, the wired connections can be, for example, twisted-pair electrical signaling via electrical cables, fiber-optic signaling via fiber-optic cables, and/or the like.

The central server 270 can be, for example, any server or cloud-based device that can be used by an enterprise (e.g., a company), an individual or a group of individuals to store, compute or communicate data. The central server 270 can be stationary and can have storage elements, communication elements and processing elements. The central server 270 can include multiple components, for example, rack mounted servers, tower servers, blade servers, mainframes, computing clusters, cloud computing services, cloud storage services, storage arrays, redundant array of independent disks (RAID) storage arrays, and/or the like. The central server 270 can be connected to the Internet via high speed connections such as T-level connections, fiber optics, and/or the like. The central server can 270 organize and collate the demographic, environmental, business and operational data into multiple databases 274-279 as described in greater detail herein. The databases 274-279 can be queried by a variety of external applications to put the information to use. Such external applications can be for, for example, advertising networks, research institutions, business research, marketing planners and strategists, urban planners, news networks, and/or the like.

The central server 270 includes a memory 272, a processor 280 and a communication interface 296. The memory 272 can be, for example, a random access memory (RAM), a memory buffer, a hard drive, a database, an erasable programmable read-only memory (EPROM), an electrically erasable read-only memory (EEPROM), a read-only memory (ROM) and/or so forth. The memory 272 can store instructions to cause the processor 280 to execute modules, processes and/or functions associated with the central server 270 and/or the DEBO measurement system 200. The memory 272 includes a demographic database 274, a mobile device location database 275, an environmental database 276, a business database 277, an operational database 278, and a trends database 279.

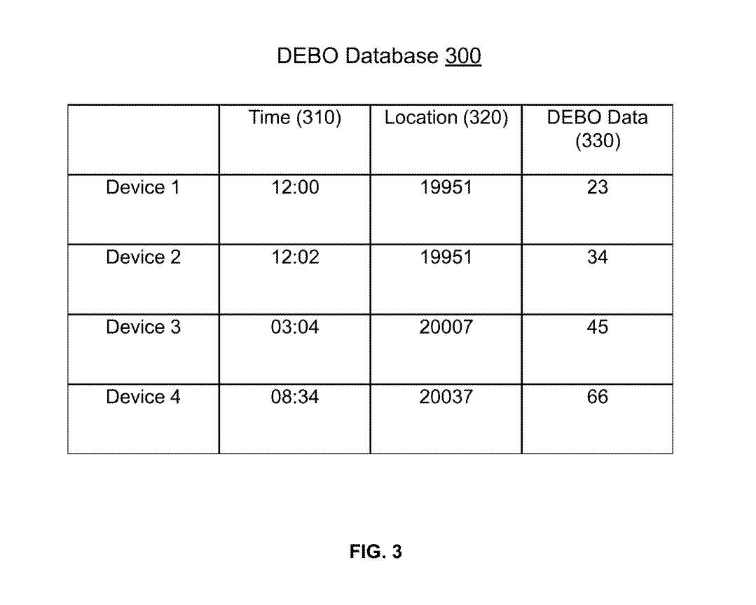

The demographic database 274 can be a lookup table or a dedicated memory space that can store demographic information of users associated with the set of mobile compute devices in multiple geographical areas. Examples of demographical information can include photographs of users, infra-red facial profile of users, retinal scan images users, fingerprint scan images of users, user name, user date of birth, user marital status, user sex, user income levels, user address, and/or the like. The information stored in the demographic database 274 can be updated repeatedly or substantially periodically by the mobile device data collection module 284. The information stored in the demographic database 274 can be accessed by the correlator module 288 to define one or multiple trends associated with a given geographical area at a given time. Additionally, the information stored in the demographic database 274 can be accessed by the prediction module 288 to make predictions on future trends for a given geographical area. Additional details about the internal structure of the demographic database 274 will be discussed in relation to FIG. 3.

The mobile device location database 275 can be a lookup table or a dedicated memory space that can store location data obtained from the set of mobile compute devices such as, for example, latitude, longitude, global positioning system (GPS) coordinates, street address, zip code, and/or the like. The mobile device location database 275 can also store and time data for a time associated with the location of different mobile compute devices such as, for example, time zone, timestamp, daylight savings time (in hours, minutes, seconds), and/or the like. The information stored in the mobile device location database 275 can be updated substantially periodically by the mobile device data collection module 284. The information stored in the mobile device location database 275 can be accessed by the correlator module 288 to define one or multiple trends associated with a given geographical area at a given time. Additionally, the information stored in the mobile device location database 275 can be accessed by the prediction module 288 to make predictions on future trends for a given geographical area. Additional details about the internal structure of the mobile device location database 275 will be discussed in relation to FIG. 3.

The environmental database 276 can be a lookup table or a dedicated memory space that can store environmental information received from the remote sensory device 250. Examples of such environmental information (or data) can include, for example, the temperature, the ambient light level, the barometric pressure, the rain fall, the pollution, the air quality, allergens, radioactivity, wind speed, wind direction, water levels, noise levels, the number of people and/or vehicles in a given vicinity of the remote sensory device 250, and/or the like. The information (or data) stored in the environmental database 276 can be updated substantially periodically by the environmental data collection module 286. The information stored in the environmental database 276 can be accessed by the correlator module 288 to define one or multiple trends associated with a given geographical area at a given time. Additionally, the information stored in the environmental database 276 can also be accessed by the prediction module 288 to make predictions on future trends for a given geographical area. Additional details about the internal structure of the environmental database 276 will be discussed in relation to FIG. 3.

The business database 277 can be a lookup table or a dedicated memory space that can store business data associated with a given geographical area that is collected or received by the business data collection module 292. Examples of such business data can include product inventory level associated with a geographic area, financial data associated with a geographical area, operating hours of a store within a geographic area, employee data associated with a geographic area, customer data associated with a geographic area, and/or the like. The information stored in the business database 277 can be updated repeatedly or substantially periodically by the business data collection module 292. The information stored in the business database 277 can be accessed by the correlator module 288 to define one or multiple trends associated with a given geographical area at a given time. Additionally, the information stored in the business database 277 can also be accessed by the prediction module 288 to make predictions on future trends for a given geographical area. Additional details about the internal structure of the business database 277 will be discussed in relation to FIG. 3.

The operational database 278 can be a lookup table or a dedicated memory space that can store operational data associated with any mobile compute device from a set of mobile compute devices and/or a service in a given geographical area. Such operational data can include, for example, device status, operating temperature, rate of prediction, efficiency data, current load, errors, warnings, versions, number of connected users, and/or the like. The information stored in the operational database 278 can be updated repeatedly or substantially periodically by the operational data collection module 290. The information stored in the operational database 278 can be accessed by the correlator module 288 to define one or multiple trends associated with a given geographical area at a given time. Additionally, the information stored in the operational database 278 can also be accessed by the prediction module 288 to make predictions on future trends for a given geographical area. Additional details about the internal structure of the operational database 278 will be discussed in relation to FIG. 3.

The trends database 279 can be a lookup table or a dedicated memory space that can store data associated with multiple trends generated by the correlator module 288 that are associated with the geographic area and multiple time periods (i.e., historical trends data). The data stored in the trends database 279 can be updated repeatedly or substantially periodically by the correlator module 288. Additionally, the data stored in the trends database 279 can also be accessed by the predictor module 288 to make predictions on future trends for a given geographical area. Additional details about the internal structure of the trends database 279 will be discussed in relation to FIG. 3.

The processor 280 can be a general purpose processor, a Field Programmable Gate Array (FPGA), an Application Specific Integrated Circuit (ASIC), a Digital Signal Processor (DSP), and/or the like. The processor 280 can run and/or execute applications, modules, processes and/or functions associated with the central server 270 and/or the DEBO system 200. The processor 280 includes an application distribution module 282, a mobile device data collection module 284, an environmental data collection module 286, a correlator module 288, an operational data collection module 290, a business data collection module 292, and a prediction module 294.

The application distribution module 282 can be a hardware module(s) and/or software module(s) (stored in memory 272 and/or executed in processor 280) that can send application files (e.g., executable files) to different mobile compute devices 210 and 230, for example, associated with users that are authenticated and registered customers of the enterprise that is the owner of the central server 270. The application distribution module 282 can send the application file(s) as, for example, as executable file(s), via the network 260 to the mobile compute device 210 and 230. Such an executable file(s) can then be installed, for example, locally by the processor 216 on the mobile compute device 210 or the processor 236 on the mobile compute device 230.

The mobile device data collection module 284 can be a hardware module(s) and/or software module(s) (stored in memory 272 and/or executed in processor 280) that can receive from each mobile compute device 210 (or 230) from a set of mobile compute devices demographic information associated with the user of that mobile compute device. Examples of demographic information that can be received by the mobile device data collection module 284 include a picture photograph of the user, an infra-red facial profile of a user, a retinal scan image of a user, a fingerprint scan image of a user, information associated with physical attributes of a user, a user name, a user date of birth, a user marital status, a user sex, an income level of a user, an address of a user, an employer identity of a user, a hobby of a user, and/or the like. The mobile device data collection module 284 can store the received demographic information associated with the user of each mobile compute device from the set of mobile compute devices into the demographic database 274 of the central server 270 for future processing and trend generation and prediction.

The mobile device data collection module 284 can also repeatedly receive from each mobile compute device 210 (or 230) from a set of mobile compute devices an indication of a location of that mobile compute device 210 (or 230) and an indication of a time associated with that location. The indication of a location of a mobile compute device 210 (or 230) can include, for example, latitude, longitude, global positioning system (GPS) coordinates, street address, zip code, and/or the like. The indication of a time associated with a location can include, for example, time zone, timestamp, daylight savings time (in hours, minutes, seconds), and/or the like. The mobile device data collection module 284 can identify based on the indication of the location and the indication of the time associated with each mobile compute device 210 (or 230) from the set of mobile compute devices, a collection of mobile compute devices from the set of mobile compute devices that are within a specific geographic area (e.g., a city, a zip code, a metropolitan area, a block, etc.) during a given time period (where the number of mobile compute devices in the collection of mobile compute devices is less than the number of mobile compute devices in the set of mobile compute devices).

In some instances, the mobile device data collection module 284 can access stored historical location data associated with all known mobile compute devices from the mobile device location database 275 to identify the set of known mobile compute devices in a given geographical area. In such instances, the mobile device data collection module 284 can match the location and time information received from a set of mobile compute devices within a given time period with such stored historical location data to facilitate the identification of the collection of mobile compute devices from the set of mobile compute devices that are within a specific geographic area (e.g., a city, a zip code, a metropolitan area, a block, etc.) during a given time period.

The environmental data collection module 286 can be a hardware module(s) and/or software module(s) (stored in memory 272 and/or executed in processor 280) that can repeatedly receive from the remote sensory device 250 associated with a given geographical area, environmental information associated with the geographical area during a given time period. Such environmental information can include, for example, the temperature, the ambient light level, the barometric pressure, the rain fall, the pollution, the air quality, allergens, radioactivity, wind speed, wind direction, water levels, noise levels, the number of people and/or vehicles in a given vicinity of the remote sensory device 250, and/or the like. The environmental data collection module 286 can store the received environmental information associated with a given geographical area into the environmental database 276 of the central server 270 for future processing and trend generation and prediction.

The operational data collection module 290 can be a hardware module(s) and/or software module(s) (stored in memory 272 and/or executed in processor 280) that can collect operational data from any mobile compute device from the set of mobile compute devices and/or a service. Such operational data can include, for example, device status, operating temperature of a device, rate of prediction, efficiency data, current load of a device, errors, warnings, versions, number of connected users, and/or the like. The operational data can be collected directly by the central server 270 where repeated or substantially periodic requests for readings can be sent by the operational data collection module 290 to a wide range of sensors designed to give operational feedback over the network 260. The results can be sorted by the operational data collection module 290 according to, for example, geographical location and data type (e.g., Boolean, counter, float, text, etc.) and stored in the operational database 278 for future processing and trend generation and prediction.

The business data collection module 292 can be a hardware module(s) and/or software module(s) (stored in memory 272 and/or executed in processor 280) that can collect business data that can include information that can be connected to the running of a business, group, corporation, individually-owned company or partnership in one or multiple geographical areas. Such data may include, for example, product stocks, sales figures, operating hours, financial data, sales targets, profit margins, employee data, customer data, and/or the like. In some instances, the business data collection module 292 can directly capture or collect business data by, for example, sending repeated or substantially periodic queries, with parameters defined by the business owner, from the business data collection module 292 to a business database over the network 260. In other instances, the business data collection module 292 can implement a web crawling or spidering software to obtain business data from the web content of a third party (i.e., a business). Such web crawlers can copy the third-party web pages for subsequent processing by a search engine in the business data collection module 292 that can index the downloaded pages so that relevant business data can be obtained. The results of such queries (i.e., business data) can be sorted by the business data collection module 292 according to, for example, geographical location and business metric. Such sorted or organized business data can be sent by the business data collection module 292 to the business database 277 for storage and further processing.

The correlator module 288 can be a hardware module(s) and/or software module(s) (stored in memory 272 and/or executed in processor 280) that is operatively coupled to at least the mobile device data collection module 284 and the environmental data collection module 286. In some instances, the correlator module 288 can identify a collection of mobile compute devices from the set of mobile compute devices based on a correlation between a geographic area and time period associated with the data being received from the remote sensory device 250 and the location and time information associated with the data being received from each mobile compute device 210 (or 230) from the set of mobile compute devices (where the number of mobile compute devices in the collection of identified mobile compute devices is less than the number of mobile compute devices in the set of mobile compute devices).

In some instances, the correlator module 288 can correlate, based on the geographic area and time period, the demographic information related to users associated with associated with the collection of mobile compute devices with environmental information to define, for example, a first trend associated with the geographic area and the time period. In such instances, the correlator module 288 can generate and send a signal including an indicator associated with the first trend to, for example, the trends database 279 and/or to a third party (enterprise) server (e.g., enterprise servers 125-127 in FIG. 1). In other instances, the correlator module 288 can correlate the business data collected in a geographic area at a given time period with the demographic information related to users associated with the collection of mobile compute devices in the geographic area at the given time period and the environmental information (obtained from the remote sensory device 250) associated with that geographic area at that given time period to define, for example, a second trend that is associated with the given geographical area in the given time period. In other instances, the correlator module 288 can correlate the operational data received (as described above) associated with a geographic area at a given time period with the demographic information related to users associated with the collection of mobile compute devices in the geographic area at the given time period and the environmental information associated with the given geographic area in that given time period to define, for example, a third trend associated with the given geographic area and the given time period. In yet other instances, the correlator module 288 can correlate, based on the geographic area, the demographic information related to users associated with the collection of mobile compute devices (in the given geographic area in the given time period) with the business information associated with that geographic area at that given time period and the environmental information associated with that geographic area at that given time period to define, for example, a fourth trend associated with the given geographic area. In such instances, the correlator module 288 can generate and send a signal including an indicator associated with the fourth trend to, for example, the trends database 279 and/or to a third party (enterprise) server (e.g., enterprise servers 125-127 in FIG. 1). Such trends can, be for example, current business and/or market trends that can, for example, assist a third party (e.g., business enterprises) to launch a new product.

The correlator module 288 can process multiple DEBO variables that are being tracked over time and geographical locations, and can compare the DEBO parameters (or variables) to one another using any number of correlation algorithms and/or formulas (e.g., fast approximate correlation, cross-correlation, correlation clustering, etc.). Application of such correlation methods results in a percentage or coefficient value that is proportional to how mathematically correlated the DEBO parameters (or variables) are. For example, if two or more variables are correlated above a pre-determined threshold, the DEBO parameters (or variables) are identified to form a trend, which defines two or more related data points/variables. This trend can then be recorded by the correlator module 288 into the trends database 279. This new trend data can be used to predict or infer one DEBO parameter (or variable) using the correlated coefficient or percentage value.

The prediction module 294 can be a hardware module(s) and/or software module(s) (stored in memory 272 and/or executed in processor 280) that can use the previous historical DEBO data associated with a given geographical area and past trends (e.g., stored in the trends database 279) to project (forward in time) the DEBO conditions in the future for the given geographical area. The prediction module 294 can implement multiple known predictive analysis and modeling methods to make such predictions of future trends. For example, the prediction module 294 can implement a variety of statistical techniques from modeling, machine learning, and data mining that can analyze current and historical DEBO data and past trends to make predictions about future, or otherwise unknown, trends (or events) in a given geographical area. The approaches and techniques used by the prediction module 294 to conduct predictive analysis can broadly be grouped into regression techniques and machine learning techniques such as, for example, linear regression model, discrete choice models, logistic regression, multinomial logistic regression, time series models, classification and regression trees, survival or duration analysis, and/or the like.

For example, in some instances, the prediction module 294 can predict one or multiple demographic properties of users of mobile compute devices within a given geographic area at a second time period after a first time period based on past historical trends associated with the demographic data associated with users of mobile compute devices in the geographical area (e.g., stored in the trends database 279) and demographic data received by the central server 270 of users associated with multiple mobile compute devices in the geographical area in the first time period. In other instances, the prediction module 294 can make predictions on future trends based on new and historical (or stored) business data and historical trends. In yet other instances, the prediction module 294 can make predictions on future trends based on new and historical (or stored) operational data and historical trends. Such predictive analysis techniques can be used by the prediction module 294 to make future predictions pertaining to various fields such as, for example, actuarial science, marketing, financial services, insurance, telecommunications, retail, travel, healthcare, pharmaceuticals, and/or the like.

The central server 270 also includes a communication interface 296, which is operably coupled to the communication interface 258 of the remote sensory device 250 and the communication interfaces 222 and 242 of the mobile compute devices 210 and 230, respectively. The communication interface 296 can include one or multiple wireless port(s) and/or wired ports. The wireless port(s) in the communication interface 296 can send and/or receive data units (e.g., data packets) via a variety of wireless communication protocols such as, for example, a wireless fidelity (Wi-Fi®) protocol, a Worldwide Interoperability for Microwave Access (WiMAX) protocol, a cellular protocol (e.g., a third generation mobile telecommunications (3G) or a fourth generation mobile telecommunications (4G) protocol), 4G long term evolution (4G LTE) protocol), and/or the like. In some instances, the wired port(s) in the communication interface 296 can also send and/or receive data units via implementing a wired connection to the remote sensory device 250 and/or the mobile compute devices 210 and 230. In such instances, the wired connections can be, for example, twisted-pair electrical signaling via electrical cables, fiber-optic signaling via fiber-optic cables, and/or the like.

FIG. 3 illustrates an example of the file structure of a DEBO database in the central server, according to an embodiment. The DEBO database 300 is stored in the memory of the central server and can be representative of any of the DEBO databases shown in FIG. 2 such as, for example, the demographic database 274, the mobile device location database 275, the environmental database 276, the business database 277, the operational database 278, or the trends database 279. The DEBO database 300 shown in FIG. 3 including data from four devices as an example only, and not a limitation. In other configurations, the DEBO database 300 can include data from n devices; where n can be any integer.

The DEBO database 300 is structured with at least one column for time information (310), at least one column for location information (320) and one or more columns for DEBO data elements (330). The DEBO data elements shown in FIG. 3 are demographic data associated with users such as, for example, the age of a user of a mobile compute device. The time column 310 may be parsed or translated into multiple columns indicating, for example, time zone, timestamp, daylight savings time and/or the like. The location column 320 may be parsed or translated into multiple columns indicating, for example, latitude, longitude, GPS coordinates, street address, zip code and/or the like. The location entries in the DEBO database 300 in FIG. 3 is the zip code of the location of the mobile compute device. Regardless of the specific format or number of columns used to indicate time, location and DEBO data, the three columns shown in FIG. 3 represent an example structure of a DEBO database stored in the central server.

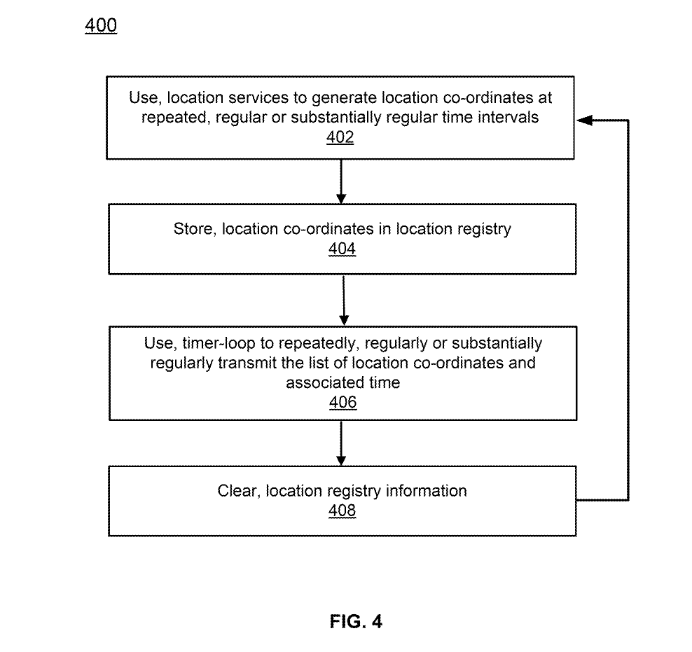

FIG. 4 is a flowchart illustrating a method used by a mobile compute device to repeatedly or regularly track its location and transmit the location information to the central server to be processed into demographic information, according to an embodiment. The method 400 includes using location services to generate location co-ordinates at repeated, regular or substantially regular time intervals, at 402. The mobile compute device can use location multiple services such as GPS, inertial systems, Wi-Fi® based location services (among others) to generate location coordinates at repeated, regular or substantially regular time intervals. As described above, the location co-ordinates can include, for example, latitude, longitude, global GPS coordinates, street address, zip code, and/or the like.

At 404, the location co-ordinates generated at repeated, regular or substantially regular time intervals is stored at, for example, a location registry. The location registry can be a database or lookup table stored in the memory of the mobile compute device that can temporarily store the location and time information. At 406, a timer loop sequence is used to repeatedly, regularly or substantially regularly transmit the location co-ordinates and any associated time information to, for example, the central server to be cross referenced with associated demographic data. Note that the time information associated with the location data can be added by the mobile compute device or the central server or both devices and can include, for example, the time zone, timestamp, daylight savings time (in hours, minutes, seconds), and/or the like. At 408, the stored location registry information is cleared or deleted by, for example, the processor of the mobile compute device and the process repeats.

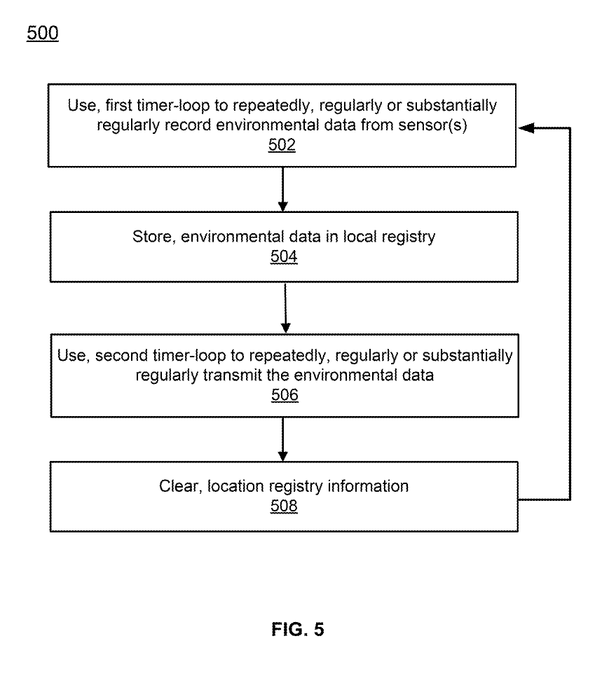

FIG. 5 is a flowchart illustrating a method used by a remote sensory device to receive environmental data and periodically transmit the environmental data to the central server, according to an embodiment. The method 500 includes using a first timer loop to repeatedly, regularly or substantially regularly obtain or detect environmental data from different sensors, at 502. As described above, environmental data can be collected by the remote sensory device using sensor (or sensor arrays) that can be either directly mounted on the remote sensory device and/or remotely coupled to the remote sensory device. Such sensors can measure, for example, the temperature, the ambient light level, the barometric pressure, the rain fall levels, the pollution levels, the air quality levels, allergens, radioactivity, wind speed, wind direction, water levels, noise levels, the number of people and/or vehicles in a given vicinity of the remote sensory device, and/or the like. Weather-related data such as rainfall, wind speed, wind direction and temperature can be recorded from a weather sensor kit. Sound levels and sound frequencies can be recorded by a microphone. People count, car count and ambient light readings can be taken from a camera.

At 504, a set of such environmental data can be stored at a registry included within or coupled to the remote sensory device. At 506, a second timer loop sequence is used to repeatedly, regularly or substantially regularly transmit the environmental data and any associated time information to, for example, the central server for storage and further processing. Note that the time information associated with the environmental data can be added by the remote sensory device or the central server or both devices and can include, for example, the time zone, timestamp, daylight savings time (in hours, minutes, seconds), and/or the like. Note that in some instances, the first timer loop can be the same as the second timer loop, and in other instances, the first timer loop can be different from the second timer loop. At 508, the stored local registry information is clear or deleted by, for example, the processor of the remote sensory device and the process repeats.

In some instances, the DEBO system shown and described in FIGS. 1-5 can be used to facilitate a “pay-per-view” accounting scheme for a customer (e.g., a third-party enterprise such as an advertising agency, a broadcaster, a cable company, etc.). In such instances, “pay-per-view” (PPV) can be a type of paid product or service (e.g., a television program, an advertisement, etc.) that a subscriber (e.g., a viewer) to a service provider (where the service provider is the customer described above and can be, for example, a broadcaster, an advertising agency, a cable company, etc.) can purchase via private telecast. The service provider transmits the event at the same time to the subscribers ordering the product or service. PPV product or service can be charged by the service provider to the subscriber as determined by the ratio of the number of potential subscribers to the number of actual or predicted subscribers. In such instances, the customer (e.g., a third-party enterprise such as an advertising agency, a broadcaster, a cable company, etc.) can define a geographic location where a product or service is being presented. The location coordinates are sent to the central server (e.g., central server 170 in FIG. 1) from the customer's device (e.g., enterprise server 125 in FIG. 1) with a request for the number of views at the pre-determined geographical location. The central server can search for nearby remote sensory devices (RSDs) (e.g., remote sensory device 150 in FIG. 1) with, for example, people and/or vehicle counting abilities. In such instances, if such RSDs are in the pre-determined geographic location, the actual viewer count can be provided. If not and none of the RSDs are at the geographic location coordinates sent by the customer, the viewer count can be estimated by the central server using, for example, cell tower triangulation methods. The viewer count can be estimated by, for example, the number of vehicles and/or the number of pedestrians in a given broader geographical area. The viewer count (actual or predicted) can be sent by the central server to the customer; the customer can then charge an appropriate amount per subscriber (e.g., viewer) to view a PPV content and thus determine the final price for each view.

In other instances, the DEBO system shown and described in FIGS. 1-5 can be used to facilitate a “pay-per-relevance” accounting scheme for a customer (e.g., a third-party enterprise such as an advertising agency, a broadcaster, a cable company, etc.). In such instances, “pay-per-relevance” can be defined as the charge made for a product or service as determined by the difference between the target DEBO data parameters against the predicted DEBO data measurements. In such instances, a customer can first define a set of “optimal” or “target” parameters. Such parameters can include a variety of DEBO data such as, for example, ideal or target user age (or user age range), user sex, sales, temperature (or temperature range), and/or the like. These optimal or target parameters can then be saved either on a local customer database or on the central server. As described above, the customer can also define a geographic location (or geographic area) and time period where a product or service is being presented. A request can be sent to the central server for “pay-per-relevance” prediction. Using a similar triangulation/estimation method as described above, the average DEBO data for that geographic location (or geographic area) can be determined by the central server and returned to the customer. The optimal or target DEBO data can then be compared with the actual measured DEBO data to define a percentage of accuracy. That percentage of accuracy can then be multiplied by an optimal or target rate to determine a final price for the pay-per-relevance scheme.

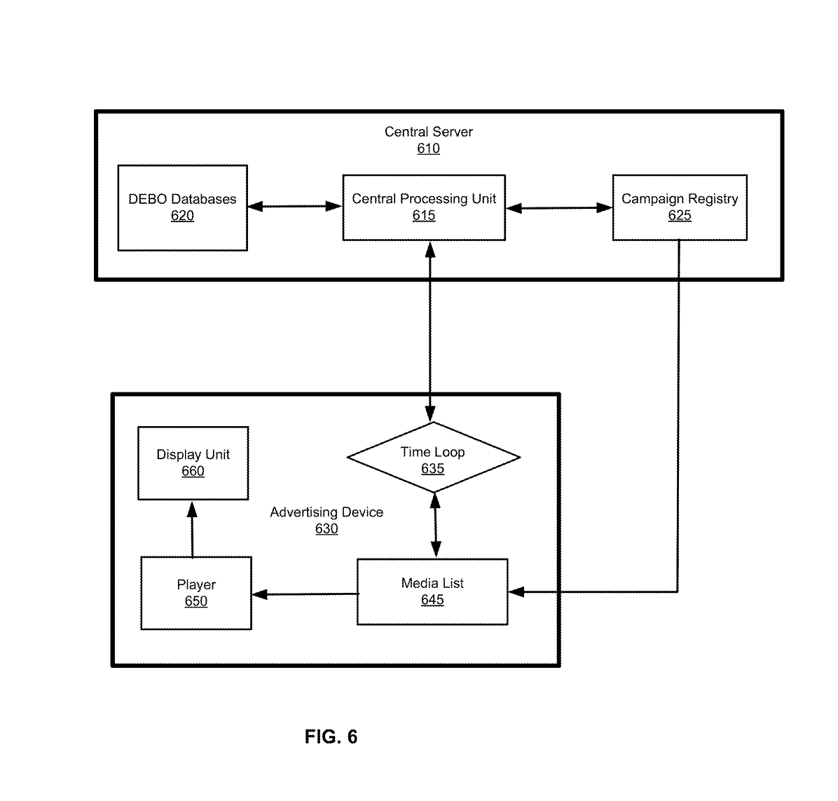

FIG. 6 is a block diagram of a DEBO system used to deliver relevant advertising content to an advertising device, according to an embodiment. The central server 610 is similar to the central servers discussed in FIGS. 1 and 2 and is part of a DEBO system. The advertisement delivery process involves a customer/advertiser defining a campaign by uploading an advertising content such as an image, video or sound file to the central server 610. Note that multiple customers of the DEBO system can load their individual advertising contents to the central server 610. The customer/advertiser can also add the target DEBO parameters for the advertising content to define the target audience, environment and business parameters. The uploaded advertising content and target DEBO parameters are stored in a campaign registry 625. The campaign registry 625 can be a lookup table or a dedicated memory space in the memory of the central server 610 that can store advertising content from different customers of the DEBO system. As in FIG. 1, the central server 610 also includes the DEBO databases 620 that can store DEBO data that are sent either from a set of mobile compute devices and/or remote sensory devices (not shown in FIG. 6) and by external inputs for business and operational information.

In some instances, the advertising device 630 can be, for example, devices associated with “real-world” or Out-Of-Home (OOH)/Digital Out-Of-Home (DOOH) advertising such as, for example, digital advertisement billboards, posters, and screens that use light-emitting diode (LED) screen-based media, liquid crystal display (LCD) screen-based media, and/or the like. In other instances, the advertising device 630 can be, for example, smart phones, cellular phones, laptop computers, tablets, desktop computers, web-enabled appliances, vehicles with internet capabilities, television sets, and/or the like. The advertising device 630 can include a display unit 660, a player 650 and a media list 645. The display unit 660 can be, for example, a liquid crystal display (LCD) unit or a light emitting diode (LED) alpha-numeric display unit that can display an advertisement sent from the central server 610. The player 650 can be part of the processor of the advertising device 630 (e.g., similar to processor 280 in FIG. 2) and can process the content of the advertisement for display on the display unit 660 (e.g., filtering, digitizing, interpolating, etc.). The media list 645 can be a part of the memory of the advertising device 630 and can store the playlist of different advertisements to display on the display unit 660. The media list 645 can send different advertisements or indications of different advertisements to the player 650. An internal time loop 635 can repeatedly, regularly or substantially regularly check if a new advertisement is listed or identified at the media list 645. When it is determined that a new advertisement is listed or identified at the media list 645, a request for an advertisement can be made by the time loop 635 to the central server 610. The central processing unit 615 (e.g., a processor) can compare DEBO information from one or multiple RSD(s) in the defined geographic area with target data from the advertising campaign registry to determine the closest match. In some instances, the advertisement deemed most relevant is then sent from the campaign registry 625 to the media list 645 (e.g., via a network like the Internet) and is added to the media list 645 to be eventually played on the display unit 660. In other instances, the central server 610 can send a pointer to an advertisement stored in a third-party device that is deemed most relevant (i.e., closest match to the target data) to the media list 645. Using such a DEBO system for targeted advertisement display results in a highly relevant advertising space within the screen of the display unit 660 that can maximize the use of screen space and viewers, while delivering significantly more relevant advertising to the targeted demographic in a particular environment, given current and relevant business and operational data.

In some instances, the DEBO system shown and described in FIGS. 1-5 can be used to deliver location- and time-based DEBO research data to a customer (e.g., a third party enterprise such as an advertising agency or a cable company). In such instances, the relevant DEBO data can also be stored in database(s) by the central server. Such DEBO data can be received from one or multiple RSD's that can repeatedly, regularly or substantially regularly send environmental data, and external inputs for business and operational information. The customer can structure a single or multi-component search using a variety of DEBO sub-queries. The sub-queries can be compiled into a single query with an attached optional time and location information. In such instances, the query can be received by the central server and the database(s) can be searched to generate the raw data. The raw data can be overlaid on a map of the geography in question and sent to the customer for review. The query can be adjusted with new DEBO or time and location information and outcomes can be compared. This method can be useful, for example, in comparisons of statistical information between time frames such as the current year compared with one or multiple past years. This can also be useful, for example, in measuring the impact of new infrastructure both before and after the construction/implementation of the DEBO system. The construction/implementation of the DEBO system can be of further use, for example, to business enterprises preparing to launch a new product that desires added in-depth research into current business and/or market trends.

In some instances, the DEBO system shown and described in FIGS. 1-5 can be used to deliver highly accurate search results from an existing online search engine such as Google™ Bing™, Yahoo®, etc. As shown in FIG. 2, DEBO data is stored in multiple databases by the central server. Such DEBO data can be received by a set of mobile compute devices and/or a set of RSD's. In such instances, a search-engine user can form a search query and send the search query to a preferred search engine (Google™, Bing™, Yahoo®, etc.). The results of the search query can be returned in an “unsorted” manner (i.e., as the search engine deems the most relevant). The “unsorted” results that includes the associated time and location information can be sent from the customer (e.g., search engine) server to the central server of the DEBO system, where the central server can use the DEBO database to determine the “relevancy” of each of the search results (according to the time and location data sent previously). The new “sorted” results can then be sent by the central server back to the customer. The method of sorting search results through relevance described thus far can be useful in several ways. For example, in some instances, when a user searches for a local coffee shop past midnight via a search engine, the central database can re-order the search result according to a user's preference or according to which shop is open after midnight (e.g., business data).

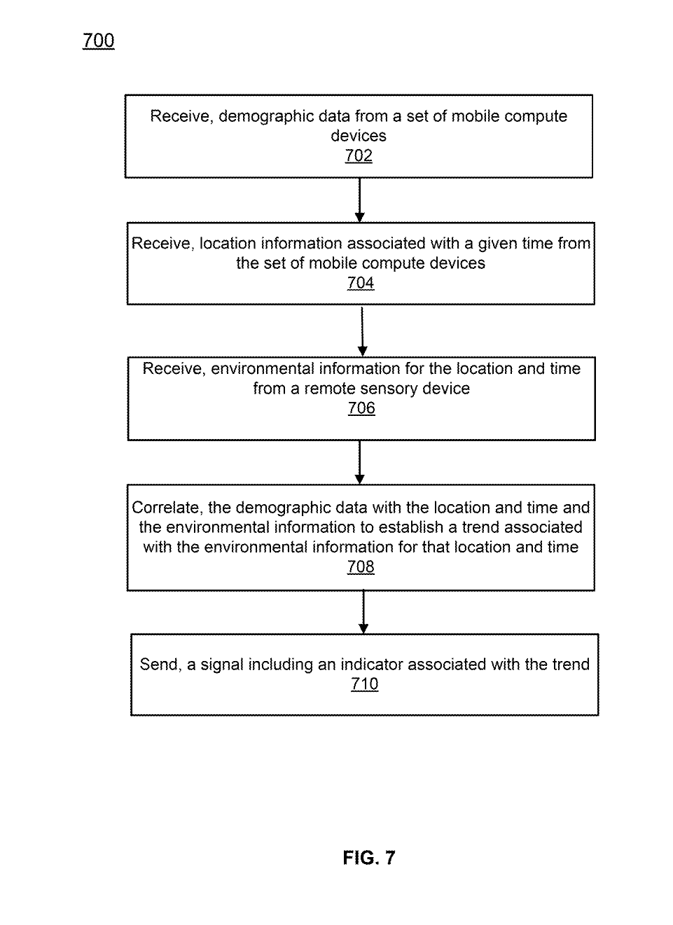

FIG. 7 is a flowchart illustrating a method of correlating DEBO parameters to define a trend associated with a geographic area and a time period, according to an embodiment. The method 700 includes receiving at, for example, a central server, demographic data from a set of mobile compute devices, at 702. As described above, the mobile compute devices can be any mobile device that can be used by an individual or a user to perform computation and/or to communicate with other devices. Such mobile compute devices can include, for example, smart phones, cellular phones, laptop computers, tablets, desktop computers, web-enabled appliances and clothing, vehicles with internet capabilities, and/or the like. As described above, the demographic data can include any piece of information that can be connected to at least one personal attribute of an individual or a user of a mobile compute device. Such data as they pertain to an individual or a group of individuals may include, for example, age, sex, physical attributes, marital status, income, physical characteristics, home address, employer and/or the like.

At 704, location information associated with a given time from the set of mobile compute devices is received at, for example, the central server. As described above, the location information received can include information associated with the location of the mobile compute devices such as for example, the latitude, the longitude, the GPS coordinates, the street address, the zip code, and/or the like.

At 706, environmental information for the location and time from remote sensory devices is received at, for example, the central server. As described above, a remote sensory device can include any device capable of sensing information about its environment, processing data from an environmental sensor array (that are either directly connected to and/or remotely coupled to the remote sensory device), and transmitting the data to, for example, a central server. The environmental sensor array can include one or more individual sensors. Such individual sensors can be, for example, one or more digital cameras, infrared cameras, ultra-violet (UV) light detectors, ambient light level sensors, laser sensors, microphones, weather sensors including instruments for measuring temperature, barometric pressure, rain fall, pollution, air quality, allergens, radioactivity, wind speed, wind direction, water levels, and/or the like.

At 708, the demographic data with the location and time information is correlated with the environmental data at, for example, the central server to establish a trend associated with the environmental information for that location and time. As described above, the correlation process can be performed at the correlator module in the central server. The correlator module can process multiple DEBO variables (environmental data, demographic data, etc.) that are being tracked over time and a given geographical location and can compare the values of the variables to one another using any number of correlation algorithms and/or formulas (e.g., fast approximate correlation, cross-correlation, correlation clustering, etc.). As described above, application of such correlation methods result in a percentage or coefficient value that is proportional to how the DEBO variables correlated are mathematically related. For example, if two or more variables are correlated above a pre-determined threshold, a trend is identified and defined based on the two or more related data points/variables. Information representing this trend can then be recorded by the correlator module into a database in the central server. This current (or historical) trend information can then be used to predict or infer one variable using a correlated element.

At 710, a signal including an indicator associated with the trend is sent by, for example, the central server. As described above, the signal can be sent by the central server to, for example, a third party (or customer) database that can allow the third party to, for example, analyze current business and/or market trends that can assist a third party (e.g., business enterprises) to launch a new product.

While shown and described above as being a single system, in some embodiments, the methods and systems illustrated in FIGS. 1-7 can be different and/or separate systems. For example, the central server shown in FIGS. 1-2 and used for registration of mobile compute devices can be different from the central server used for correlation of DEBO data to define trends. In such an embodiment, the registration system can be separate (but in communication with) the prediction system.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

What is claimed is:

1. A non-transitory processor-readable medium storing code representing instructions to be executed by a processor, the code comprising code to cause the processor to:
receive, from each mobile compute device from a plurality of mobile compute devices, demographic information associated with a user of that mobile compute device;
receive, from each mobile compute device from the plurality of mobile compute devices, an indication of a location of that mobile compute device and an indication of a time associated with that location;
identify, based on the indication of the location and the indication of the time associated with each mobile compute device from the plurality of mobile compute devices, a set of mobile compute devices (1) from the plurality of mobile compute devices and (2) identified as being within a geographic area during a time period;
receive, from a remote sensory device associated with the geographic area, environmental information associated with the geographic area during the time period;
correlate, based on the geographic area and the time period, the demographic information associated with the set of mobile compute devices with the environmental information to define a trend associated with the geographic area and the time period; and
send a signal including an indicator associated with the trend.

2. The non-transitory processor-readable medium of claim 1, wherein the demographic information includes demographic information inferred from the user's use of an associated mobile compute device from the plurality of mobile compute devices.

3. The non-transitory processor-readable medium of claim 1, wherein the time period is a first time period, the code to cause the processor to send includes code to cause the processor to send the signal such that the indicator associated with the trend is used to predict a type of individual likely to be within the geographic area at a second time period after the first time period.

4. The non-transitory processor-readable medium of claim 1, wherein the environmental information includes at least one of weather at the geographic area during the time period, an ambient light level at the geographic area during the time period, a number of individuals at the geographic area during the time period, a number of automobiles at the geographic area during the time period, an allergen level at the geographic area during the time period, a pollution level at the geographic area during the time period, or a noise level at the geographic area during the time period.

5. The non-transitory processor-readable medium of claim 1, wherein the demographic information includes at least one of an age of the user, a sex of the user, physical attributes of the user, a marital status of the user, an income of the user, an address of the user, an employer of the user, or a hobby of the user.

6. The non-transitory processor-readable medium of claim 1, further comprising code to cause the processor to:
receive business data associated with the geographic area during the time period, the code to cause the processor to correlate includes code to cause the processor to correlate the business data with the demographic information associated with the set of mobile compute devices and the environmental information to define the trend associated with the geographic area and the time period.

7. The non-transitory processor-readable medium of claim 1, further comprising code to cause the processor to:
receive operational data associated with the geographic area during the time period, the code to cause the processor to correlate includes code to cause the processor to correlate the operational data with the demographic information associated with the set of mobile compute devices and the environmental information to define the trend associated with the geographic area and the time period.

8. The non-transitory processor-readable medium of claim 1, wherein the environmental information includes an indication of a number of individuals at the geographic area during the time period, the code comprising code to cause the processor to:
compare the number of individuals at the geographic area during the time period with a number of mobile compute devices in the set of mobile compute devices to determine a number of unidentified individuals.

9. An apparatus, comprising:
a mobile device data collection module implemented in at least one of a memory or a processing device, the mobile device data collection module configured to repeatedly receive, from each mobile compute device from a plurality of mobile compute devices, an indication of a location of that mobile compute device and an indication of a time associated with that location;
an environmental data collection module configured to repeatedly receive, from a remote sensory device associated with a geographic area, environmental information associated with the geographic area during the time period;
a correlation module operatively coupled to the mobile device data collection module and the environmental data collection module, the correlation module configured to identify a set of mobile compute devices from the plurality of mobile compute devices based on a correlation between (1) a geographic area and a time period associated with the remote sensory device and (2) the location and the time for each mobile compute device from the set of mobile compute devices; and
a prediction module configured to predict a trend associated with the geographic area and the time period associated with the remote sensory device based on the set of mobile compute devices, the prediction module configured to send a signal including an indication of the trend.

10. The apparatus of claim 9, wherein the mobile device data collection module is configured to receive, from each mobile compute device from the plurality of mobile compute devices, demographic information associated with a user of that mobile compute device,
the prediction module configured to predict the trend based on the demographic information associated with the user from each mobile compute device from the set of mobile compute devices.

11. The apparatus of claim 9, further comprising:
a business data collection module operatively coupled to the prediction module, the business data collection module configured to receive business data associated with the geographic area (1) during the time period and (2) associated with the remote sensory device,
the prediction module configured to predict the trend based on the business data.

12. The apparatus of claim 9, further comprising:
an operational data collection module operatively coupled to the prediction module, the operational data collection module configured to receive operational data associated with the geographic area (1) during the time period and (2) associated with the remote sensory device,
the prediction module configured to predict the trend based on the operational data.

13. The apparatus of claim 9, wherein the environmental information includes at least one of weather at the geographic area during the time period, an ambient light level at the geographic area during the time period, a number of individuals at the geographic area during the time period, a number of automobiles at the geographic area during the time period, an allergen level at the geographic area during the time period, a pollution level at the geographic area during the time period, or a noise level at the geographic area during the time period.

14. A non-transitory processor-readable medium storing code representing instructions to be executed by a processor, the code comprising code to cause the processor to:
receive, from each mobile compute device from a plurality of mobile compute devices, demographic information associated with a user of that mobile compute device and an indication of a location of that mobile compute device;
identify, based on the indication of the location associated with each mobile compute device from the plurality of mobile compute devices, a set of mobile compute devices (1) from the plurality of mobile compute devices and (2) identified as being within a geographic area;
receive business information associated with the geographic area;
receive, from a remote sensory device associated with the geographic area, environmental information associated with the geographic area;
correlate, based on the geographic area, (1) the demographic information associated with the set of mobile compute devices with the (2) business information and the environmental information, to define a trend associated with the geographic area; and
send a signal including an indicator associated with the trend.

15. The non-transitory processor-readable medium of claim 14, wherein the business information includes at least one of a product inventory level associated with the geographic area, financial data associated with the geographic area, operating hours of a store within the geographic area, employee data associated with the geographic area or customer data associated with the geographic area.

16. The non-transitory processor-readable medium of claim 14, wherein the code to cause the processor to receive demographic information includes code to cause the processor to receive an indication of a time associated with the location of each mobile compute device from the plurality of mobile compute devices,
the code to cause the processor to identify includes code to cause the processor to identify the set of mobile compute devices based on the indication of the time associated with each mobile compute device from the plurality of mobile compute devices.

17. The non-transitory processor-readable medium of claim 14, wherein the environmental information includes at least one of weather at the geographic area, an ambient light level at the geographic area, a number of individuals at the geographic area, a number of automobiles at the geographic area, an allergen level at the geographic area, a pollution level at the geographic area, or a noise level at the geographic area.

18. The non-transitory processor-readable medium of claim 14, wherein the demographic information for each mobile compute device from the plurality of mobile compute devices includes at least one of an age of the user of that mobile compute device, a sex of the user of that mobile compute device, physical attributes of the user of that mobile compute device, a marital status of the user of that mobile compute device, an income of the user of that mobile compute device, an address of the user of that mobile compute device, an employer of the user of that mobile compute device, or a hobby of the user of that mobile compute device.

19. The non-transitory processor-readable medium of claim 14, wherein the code to cause the processor to receive demographic information includes code to cause the processor to receive demographic information for each mobile compute device from the plurality of mobile compute devices inferred from the use of that mobile compute device from the plurality of mobile compute devices.

20. The non-transitory processor-readable medium of claim 14, further comprising code to cause the processor to:
receive operational data associated with the geographic area, the code to cause the processor to correlate includes code to cause the processor to correlate the operational data with the demographic information associated with each mobile compute device from the set of mobile compute devices, the environmental information and the business information to define the trend associated with the geographic area.
